(19) United States
(12) Patent Application Publication
(10) Pub. No.: US 2018/0160414 A1
(43) Pub. Date: Jun. 7, 2018

(54) DUAL SYSTEM ACCESS WITH DIFFERENT FRAME RATES

(71) Applicant: Ingenu, San Diego, CA (US)

(72) Inventors: Theodore Myers, San Diego, CA (US); Daniel Werner, San Diego, CA (US); Dennis Espey, San Diego, CA (US)

(21) Appl. No.: 15/370,336

(22) Filed: Dec. 6, 2016

(51) Int. Cl. H04W 72/04; H04W 52/02; H04L 5/00

(52) U.S. Cl. CPC H04W 72/0406; H04L 5/0048; H04W 52/0212

(57) ABSTRACT

Methods, systems, and apparatuses, including computer programs encoded on computer-readable media, are configured for spreading, using a first data spreader, first data into a first data frame using a first spreading factor. A first transmitter transmits the first data frame to a diplexer on a first frequency. A second data spreader spreads second data into a second data frame using a second spreading factor. A second transmitter transmits the second data frame to a diplexer on a second frequency different than the second frequency. A diplexer combines the first data frame and the second data frame. A first receiver receives on the first frequency, a third data frame from the diplexer. A second receiver receives on the second frequency a fourth data frame from the diplexer.

### BACKGROUND

A number of wireless communication techniques have been developed to facilitate communication between devices. An inherent tension in the various techniques is balancing speed and reliability of data transmissions. In addition to the tension between speed and reliability, network configurations also impact the size of the coverage area. More reliable transmissions can be achieved by repeatedly transmitting the same data and/or increasing the spreading factor used to transmit data in spread spectrum communication techniques. Reducing or eliminating redundant data transmissions and/or reducing the spreading factor can be used to increase bandwidth.

Current wireless systems can balance the tension by allowing spreading factors to dynamically change during communication for a specific device. The spreading factor can be changed based upon the network environment as sensed by the specific device. The access point/network of these systems, however, use a common configuration for communication with the devices on the network. For example, the broadcast channel uses a single configuration for communication with devices accessing the network. Additionally, the full robustness of the data rates are limited to a single configuration for both the maximum spreading factor of the uplink and the downlink.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates a system with two networks having different frame rates in accordance with one implementation.

FIG. 2 is a diagram of a communication system using two frame rates in accordance with one implementation.

FIG. 3 is a diagram illustrating two frame rates in accordance with one implementation.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Described below are systems that allow the benefit of possible reduced latency and mobility without sacrificing network reliability. To achieve this, a single communication system uses two different transmission schemes. A first transmission scheme can be considered a high coverage network. A second transmission scheme is a low latency network. The high coverage network is configured such that this network is accessible more deeply compared to a low latency network. Deeply can refer to higher probability of coverage, deep in-building coverage, or combination of the two. The high coverage network, however, has a frame transmission rate that is slower than the low latency network. For example, the frame transmission rate of the high coverage network can be less compared to the frame rate of the low latency network. In various implementations, the different transmission rates are achieved using different spreading factors. For example, larger spreading factors can be used on the high coverage network, which results in more redundancy in the transmission of data but at the cost of lower bandwidth.

Even though there are two different networks, the networks are part of the same system. A device, therefore, can be on either network and will receive the appropriate data. For example, data transmissions destined for a device will reach the device regardless of the network used by that device.

The access points of the different networks can be configured to be part of the high coverage network and the low latency network. The access points can have relatively independent data streams. The signals from the two different networks can be transmitted in the same frequency band. In one implementation, the signals from the different networks can be spaced between 25 and 50 MHz from one another. In various implementations, a single antenna can be used by the access points to transmit two or more signals for the different networks. A diplexer can be used to combine multiple signals that are spread in frequency. In these implementations, a single antenna and a single cable can be used to support transmissions from and data receptions over two or more networks. This allows two access points, a single antenna, and a single cable to the antenna to support both the high coverage and low latency networks.

The two access points transmit using two different frame lengths. The shorter frame will allow the data to be transmitted in a shorter time compared to using the longer frame rate because there is a fixed latency component that is a function of frame rate. However, there may be modules that do need a spreading factor not supported by the shorter frame rate. In this case, those modules will be forced to select that longer frame rate since these modules require the robustness that only may be supported by spreading factors available in the longer frame rate.

When accessing the system, devices can search for the low latency network. If no low latency network is found, the device can then search for the high coverage network.

If only a high coverage network is found, the device can continue to search for a low latency network. For example, devices can do background scans for more preferred networks, such as a low latency network. When a device is connected to its preferred network, the device can stop looking for less preferred networks, until the preferred network is no longer available.

Devices, therefore, can attempt to be on their preferred network. The low latency network has a shorter frame length, in time, compared to the frame length of the high coverage network. A shorter frame length allows mobile devices to save battery life. This is based upon the device's shorter transmit time and also can allow a mobile device to remain off longer during slotted mode.

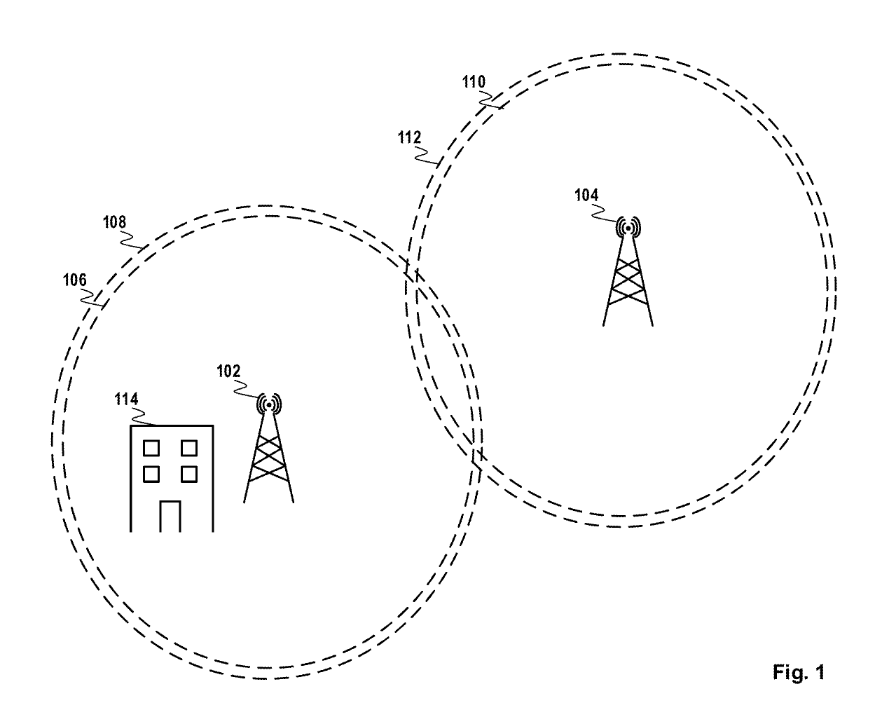

FIG. 1 illustrates a system with two networks having different frame rates in accordance with one implementation. Access point 102 supports a low latency network 106 and a high coverage network 108. Access point 104 also supports a low latency network 110 and a high coverage network 112. The low latency network 106 can use a shorter spreading factor compared to the spreading factor used on the high coverage network 108. The shorter spreading factor results in shorter data frames being transmitted on low latency networks 106 and 110. The high coverage network 108 can use longer spreading factors that result in longer transmission times for data frames. If the transmission power from the access point 102 is the same for both the low latency network 106 and the high coverage network 108, the coverage area of the higher coverage network 106 will be deeper than the low latency network 108.

The high coverage network 108 allows modules to access the network that are in areas that make the low latency network 106 hard to reach. For example, a module can be underground or located in a building or valley that blocks or degrades signals of the low latency network. For example, a module can be located in a building 114 that due to its construction shields or blocks signals from the low latency network 106. In this example, the module will not be able to access the low latency network 106 consistently. The module, however, can still access the network using the high coverage network 108. The longer spreading factors available in the high coverage network 108 allow the module to correctly receive signals from the high coverage network. For example, the longer spreading factors can be used on the broadcast frames from the high coverage network 108. The module can also use longer spreading factors to send data to the high coverage network 108. Nothing, however, prevents the module from using shorter spreading factors if the high coverage network 108 can correctly receive data from the module. For example, the module can receive broadcast frames that were spread with spreading codes that are longer than the spreading codes used on the low latency network. The module, however, can still use spreading codes that are shorter than those used in the broadcast frame to transmit data to the high coverage network 108. This allows the module and the network the flexibility to use the best/shortest spreading codes for transmitting/receiving data.

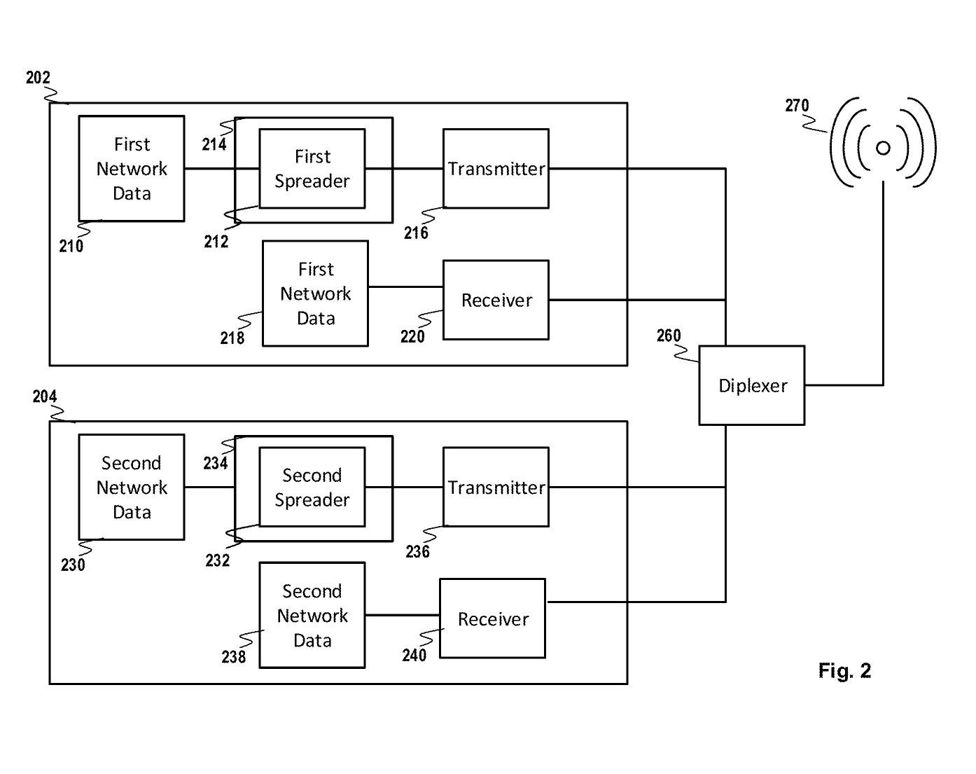

FIG. 2 is a diagram of a communication system, including two access points 202 and 204, using two frame rates in accordance with one implementation. In various implementations, data is to be transmitted on both the high coverage and the low latency networks. The access point 202 transmits and receives data on of the two networks. First network data 210 that is to be transmitted is provided to a transmit chain 214. The transmit chain 214 includes a first spreader 212 in addition to known components used to prepare the data 210 for transmission. The first spreader 212 spreads the data 210 by a first spreading factor. The spread data is then sent to a transmitter 216 that transmits the spread data to an antenna 270. Prior to over the air transmission, the spread data passes through a diplexer 260 that combines the data with spread data from the access point 204.

The access point 204 supports either the high coverage or the low latency network, such that the access points 202 and 204 provide both the high coverage and the low latency network. The access point 204 contains elements similar to the elements in access points 202. Data 230 to be transmitted is provided to a transmit chain 234. The transmit chain 234 includes a first spreader 232 used in generation of its broadcast channel in addition to known components used to prepare the data 230 for transmission. The second spreader 232 spreads the data 230 by a second spreading factor used in generation of its broadcast channel. The spread data is then sent to a transmitter 236 that transmits the spread data to an antenna 270. Prior to over the air transmission, the spread data passes through the diplexer 260 that combines the data with spread data from the access point 202.

The spread data from the access points 202 and 204 will be transmitted over two separate frequency ranges. In one implementation data is transmitted in a 25 MHz range. The diplexer 260 passes the data signal from the antenna 270 to a receiver 220 of the first access point 202 and a receiver 240 of the second access point 204. The diplexer also combines data from the transmitter 216 and the transmitter 236. The combined signal contains both the high coverage data signal that has a longer frame size compared with the low latency signal. The low latency signal is also part of the combined signal. A module that receives the combined signal, therefore, has the ability extract the data from either network. As described above, if the module is unable to join the low latency network, the module can still send and receive data via the high coverage network.

The communication system can also use the antenna 270 to receive data, via receivers 220 and 240, from multiple modules on both the low latency network and the high coverage network. The received signal will contain data from both networks. The diplexer filters the received signal into signals corresponding to the different networks based upon frequency. Similar to the transmission of the data signals, the received signals from the different networks are separated via frequency bands. The diplexer 260 filters the data in the corresponding frequency bands to provide the data from the first network 218 and the data from the second network 238.

The modules do not require the diplexer 260 to operate. While modules can access the system via either the low latency network or the high coverage network, the modules do not access both systems simultaneous. Accordingly, modules do not require the diplexer 260 to operate.

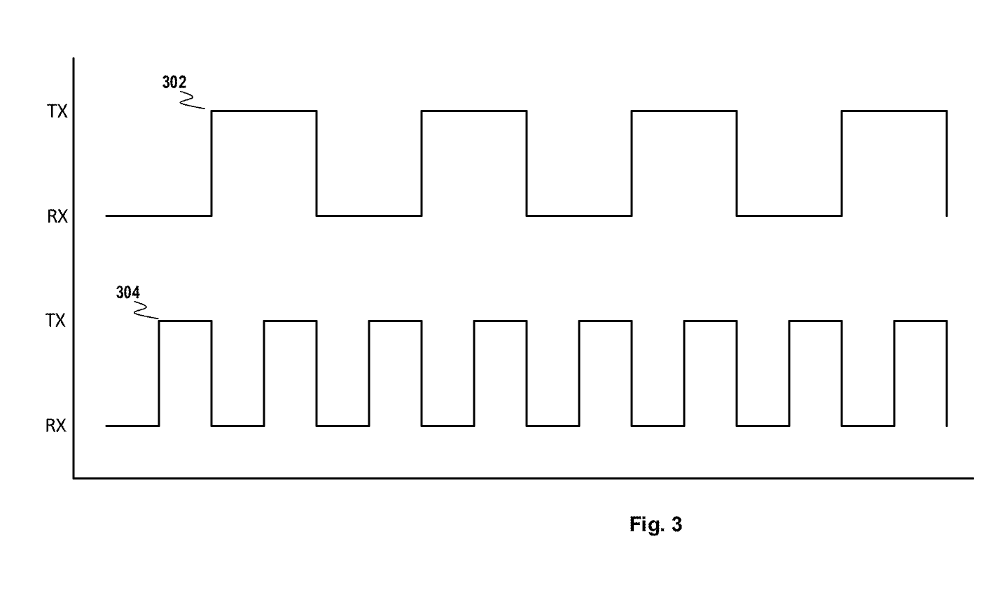

FIG. 3 is a diagram illustrating two frame rates in accordance with one implementation. A data transmission/reception schedule is shown for both a low latency network 304 and a high coverage network 302. The low latency network shows that the amount of time used to transmit one or more frames is less than the transmission time of one or more frames on the high coverage network. The transmission times for the high coverage network can be 2.3 second, 4.3 second, etc. The transmission times for the low latency network are some fraction less. For example, the transmission time can be ¼, ⅛, or 1/16 less. As shown in FIG. 2, transmitting and receiving data on one of the networks are separated in time, such that the system is a half-duplex system.

In various implementations, a data transaction completes in less time on the low latency network compared with the high coverage network. As an example, a data transaction can be a parking meter payment or a credit card sale. Regardless of the network used, the data transaction can have the same amount of data that is transmitted to and from a module. The decrease in data transaction completion time is due to the smaller spreading factor used on the low latency network. The transmission time of data from the module is reduced due to the smaller spreading factor compared to the spreading factor used in the high coverage network.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A communication system comprising:
a first access point comprising:
a first data spreader that spreads first data into a first data frame using a first spreading factor to create first spread data;
a first transmitter configured to transmit the first spread data to a diplexer on a first frequency; and
a first receiver configured to receive third spread data from the diplexer;
a second access point comprising:
a second data spreader that spreads second data into a second data frame using a second spreading factor to create second spread data;
a second transmitter configured to transmit the second spread data to the diplexer on a second frequency different than the first frequency;
a second receiver configured to receive fourth spread data from the diplexer; and
the diplexer that combines the first spread data and the second spread data to create combined data, wherein the combined data is provided to antenna.

2. The communication system of claim 1, wherein a length of the first data frame is shorter than a length of the second data frame.

3. The communication system of claim 1, wherein the first spreading factor is shorter than the second spreading factor.

4. The communication system of claim 1, wherein the communication system further comprises the antenna used to transmit the combined data.

5. The communication system of claim 1, wherein the second data frame length is 2.3 seconds.

6. The communication system of claim 5, wherein the first data frame length is ⅛ of the second data frame length.

7. The communication system of claim 1, wherein the diplexer separates the third spread data and the fourth spread data.

8. The communication system of claim 1, wherein the third spread data is received while the second spread data is being transmitted.

9. The communication system of claim 1, wherein the first spread data and third spread data comprise a data transaction.

10. The communication system of claim 9, wherein the data transaction is a parking meter transaction.

11. A method comprising:
spreading, using a first data spreader, first data into a first data frame using a first spreading factor;
transmitting, using a first transmitter, the first data frame to a diplexer on a first frequency;
spreading, using a second data spreader, second data into a second data frame using a second spreading factor;
transmitting, using a second transmitter, the second data frame to a diplexer on a second frequency different than the second frequency;
combining, using the diplexer, the first data frame and the second data frame;
receiving, using a first receiver on the first frequency, a third data frame from the diplexer;
receiving, using a second receiver on the second frequency, a fourth data frame from the diplexer.

12. The method of claim 11, wherein a length of the first data frame is shorter than a length of the second data frame.

13. The method of claim 11, wherein the first spreading factor is shorter than the second spreading factor.

14. The method of claim 11, wherein a single antenna used to transmit the combined data.

15. The method of claim 11, wherein the second data frame length is 2.3 seconds.

16. The method of claim 15, wherein the first data frame length is ⅛ of the second data frame length.

17. The method of claim 11, further comprising separating, using the diplexer, the third data frame and the fourth data frame.

18. The method of claim 17, wherein the third data frame is received while the second data frame is being transmitted.

19. The method of claim 11, wherein the first spread data and third spread data comprise a data transaction.

20. The method of claim 19, wherein the data transaction is a parking meter transaction.
